(19) United States
(12) Patent Application Publication
(10) Pub. No.: US 2002/0110086 A1
(43) Pub. Date: Aug. 15, 2002

(54) Multiport switch and a method for forwarding variable length packets across a multiport switch

(76) Inventor: Shlomo Reches, Petach-Tiqva (IL)

Correspondence Address: MERCHANT & GOULD PC, P.O. BOX 2903, MINNEAPOLIS, MN, 55402-0903, US

(21) Appl. No.: 09/739,496

(22) Filed: Dec. 18, 2000

(51) Int. Cl. H04L 12/56

(52) U.S. Cl. 370/235; 370/389; 370/471

(57) ABSTRACT

A method for forwarding variable length packets across a multiport switch, the method comprising the steps of: (i) checking, at each time slot, forwarding requests to forward variable length packets from source ports of the multiport switch to destination ports of the multiport switch, wherein ignoring forwarding requests from source ports that were previously scheduled to forward at least a portion of a variable length packet during a next time slot and ignoring forwarding requests from destination ports that are scheduled to receive at least a portion of a variable length packet during the next time slot; (ii) selecting selected forwarding requests out of the forwarding requests; and (iii) configuring the multiport switch for allowing to service the selected forwarding requests during the next time slot.

### FIELD OF THE INVENTION

The present invention relates to a multiport switch and a method for forwarding variable length packets across a multiport switch and especially for a method for forwarding variable length packets without segmenting the variable length packets to fixed sized cells within a network element having a multiport switch.

### BACKWARD OF THE INVENTION

Multiport configurable switches, such as but not limited to crossbar switches are known in the art. Multiport configurable switched are found in many modern communication systems. A crossbar switch can allow various degrees of connectivity between its ports. A full crossbar switch allows for connecting any one of the ports to any other of the ports, while a partial crossbar connectivity allows reduced connectivity. A connection between two ports may allow uni-directional as well as bidirectional exchange of packets. Commonly, a port that provides a packet across the crossbar is referred to as a destination port or an input port while a port that received this variable length packet is referred to as a source port or an output port. Usually, each port can be a destination port as well as a source port.

A brief introduction to crossbar switches is found at “Fast Switched Backplane for a Gigabti Switched Router” by Nick McKeown. An exemplary of a multiport crossbar switch is illustrated at U.S. Pat. No. 6,052,368 of Aybay.

Both Aybay and McKeown illustrate crossbar switches that use a synchronous scheduling scheme and handle fixed length cells. Variable length packets are fragmented to a plurality of fixed length cells before being sent across the crossbar switch to be reassembled to generate variable length packets. At each time slot a plurality of fixed size cells are sent across the crossbar switch.

McKeown further illustrates a scheduling mechanism that calculates all the required connectivity of the crossbar at each time slot. A main disadvantage of these crossbar switches is that the segmentation and the reassembly are both time and resource consuming. Furthermore, the addition of control signals for allowing the segmentation and reassembly of the variable length packet reduce the throughput of the crossbar switch.

Another prior art solution for scheduling variable sized packets is to constantly track the outputs and the inputs in order to determine when variable length packets finished to traverse the crossbar switch. This method complicated the scheduling scheme and is not fitted to ultra high frequency switching.

There is a need to provide a multiport switch and a method for forwarding variable length packets across a multiport switch that allow fast and efficient flow of variable length packets. There is a need to provide a method for scheduling a multiport crossbar switch and of a crossbar switch that are simple to implement.

### SUMMARY OF THE INVENTION

The invention provides a method for forwarding variable length packets across a multiport switch. The method does not require to segment or to fragment a received variable length packet thus reducing overhead and allowing an enhanced throughput of the crossbar. The method is based upon a periodic scheduling scheme that simplifies the scheduling.

The method includes three steps of: (i) checking, at each time slot, forwarding requests to forward variable length packets from source ports of the multiport switch to destination ports of the multiport switch, wherein ignoring forwarding requests from source ports that were previously scheduled to forward at least a portion of a variable length packet during a next time slot and ignoring forwarding requests from destination ports that are scheduled to receive at least a portion of a variable length packet during the next time slot; (ii) selecting selected forwarding requests out of the checked forwarding requests; and (iii) configuring the multiport switch for allowing to service the selected forwarding requests during the next time slot.

### BRIEF DESCRIPTION OF THE DRAWINGS

While the invention is pointed out with particularity in the appended claims, other features of the invention are disclosed by the following detailed description taken in conjunction with:

FIGS. 1-2 illustrate multiport switches, according to preferred embodiments of the invention; and

FIGS. 3-6 are flow charts illustrating methods for forwarding variable length packets across a multiport switch, according to preferred embodiments of the invention.

### DETAILED DESCRIPTION OF THE DRAWINGS

It should be noted that the particular terms and expressions employed and the particular structural and operational details disclosed in the detailed description and accompanying drawings are for illustrative purposes only and are not intended to in any way limit the scope of the invention as described in the appended claims.

The invention provides a method for forwarding variable length packets across a multiport switch, the method including the steps of: (a) Checking, at each time slot, forwarding requests to forward variable length packets from source ports of the multiport switch to destination ports of the multiport switch, wherein ignoring forwarding requests from source ports that were previously scheduled to forward at least a portion of a variable length packet during a next time slot and ignoring forwarding requests from destination ports that are scheduled to receive at least a portion of a variable length packet during the next time slot. (b) Selecting selected forwarding requests out of the checked forwarding requests. (c) Configuring the multiport switch for allowing to service the selected forwarding requests during the next time slot.

The invention provides a for forwarding variable length packets across a multiport switch that further includes a step of periodically tracking the forwarding of each variable length packet across the multiport switch to determine whether the forwarding ends during the current time slot.

The invention provides a method for forwarding variable length packets across a multiport switch that further includes a step of notifying source ports that issued selected forwarding requests about the selection.

The invention provides a method for forwarding variable length packets across a multiport switch wherein the step of checking is preceded by a step of receiving variable length packets at a source port, storing the variable length packets at a queue out of at least one queue of the source port, wherein the forwarding request reflect at least a portion of the content of the queue.

The invention provides a method for forwarding variable length packets across a multiport switch that further includes a step of maintaining at each source port a queue for each level of priority of each source port, and a step of storing a variable length packet according to the priority of the variable length packet.

The invention provides a method for forwarding variable length packets across a multiport switch that further includes a step of maintaining at each source port a queue for each destination port, and a step of storing a variable length packet according to the destination port of the variable length packet.

The invention provides a method for forwarding variable length packets across a multiport switch that further includes a step of tracking the forwarding of variable length packets to determine when the forwarding of the variable length packets ends.

The invention provides a method for forwarding variable length packets across a multiport switch wherein the step of tracking includes a step of receiving a length indication being indicative of a length of a variable length packet and of a step of updating the length indication during the forwarding of the variable length packet to reflect a remaining time period until the forwarding ends.

The invention provides a method for forwarding variable length packets across a multiport switch wherein the step of selecting further includes a step of converging on a conflict free match in multiple iterations.

The invention provides a method for forwarding variable length packets across a multiport switch wherein the step of selecting is based upon a rotating priority arbitration scheme.

The invention provides a method for controlling a crossbar switch having multiple ports, the method including the steps of: (a) Periodically checking connection requests, each connection request requesting to couple a destination port of the crossbar switch to a source port of the crossbar switch, for forwarding a variable length packet from the source port to the destination port; wherein ignoring connection requests associated with each source port and destination port that is coupled to another destination port and another source port accordingly during a current time slot for forwarding at least a portion of a variable length packet, wherein the forwarding of the variable length packet is not scheduled to end during the current time slot. (b) Processing the checked connection requests to determine the connectivity of the crossbar switch during the next time slot. (c) Providing control signals to the crossbar switch in view of the determination.

The invention provides a method for controlling a crossbar switch having multiple ports that further includes a step of maintaining a crossbar switch status database indicative of the connectivity of the crossbar switch during at least the current time slot and the next time slot.

The invention provides a method for controlling a crossbar switch having multiple ports that further includes a step of receiving an END signal being indicative that a forwarding of a variable length packet is scheduled to end during the current time slot.

The invention provides a method for controlling a crossbar switch having multiple ports wherein the END signal is encoded in the connection requests.

The invention provides a method for controlling a crossbar switch having multiple ports wherein maintaining a connection between a source port and a destination port throughout the forwarding of the variable length packet.

The invention provides a method for controlling a crossbar switch having multiple ports wherein the step of processing the connection requests further includes a step of converging on a conflict free match in multiple iterations.

The invention provides a method for controlling a crossbar switch having multiple ports wherein the step of processing the connection requests is based upon a rotating priority arbitration scheme.

The invention provides a method for periodically controlling the flow of variable length packets across a multiport switch, the method including the steps of: (a) Scanning, at each time slot, for connection requests that are associated with source ports and to destination ports that are not scheduled to be busy during the next time slot. (b) Selecting a granted connection request, for each destination port that is associated with a scanned connection request. (c) Selecting an accepted connection request, for each source port that is associated with a granted connection request. (d) Allowing variable length packets to flow across the multiport switch according to the accepted connection requests.

The invention provides a method for periodically controlling the flow of variable length packets across a multiport switch wherein maintaining a connection between a source port and a destination port throughout the flow of the variable length packet.

The invention provides a method for periodically controlling the flow of variable length packets across a multiport switch wherein the steps of selecting further include a step of converging on a conflict free match in multiple iterations.

The invention provides a method for periodically controlling the flow of variable length packets across a multiport switch wherein the steps of selecting are based upon a rotating priority arbitration scheme.

The invention provides a method for controlling a configuration of a multiport switch for allowing variable length packets to flow from an input port to at least one output port of the multiport switch, the method including the steps of: (a) Scanning, at each time slot, a content of input queues within the input ports and generating flow requests for allowing variable length packet stored within the input queues to flow from input ports that were not previously scheduled to be busy during the next time slot to output ports that were not previously scheduled to be busy during the next time slot. (b) Comparing flow requests and selecting selected flow requests to be serviced during the next time slot. (c) Updating the configuration of the configurable multiport switch for allowing to service the selected flow requests.

The invention provides a method for controlling a configuration of a multiport switch for allowing variable length packets to flow from an input port to at least one output port of the multiport switch wherein each input port maintains a plurality of input queues, for differentiating between variable length packets according to at least one of the following parameters: the priority of the variable length packet, the output port associated with the variable length packet, the number of output ports associated to a single variable length packet, for example unicast, multicast or broadcast, and to the type of flow, such as unidirectional, bidirectional flow.

The invention provides a method for controlling a configuration of a multiport switch for allowing variable length packets to flow from an input port to at least one output port of the multiport switch wherein maintaining a connection between a source port and a destination port throughout the flow of the variable length packet.

The invention provides a method for controlling a configuration of a multiport switch for allowing variable length packets to flow from an input port to at least one output port of the multiport switch wherein the step of selecting further includes a step of converging on a conflict free match in multiple iterations.

The invention provides a method for controlling a configuration of a multiport switch for allowing variable length packets to flow from an input port to at least one output port of the multiport switch wherein the step of selecting is based upon a rotating priority arbitration scheme.

The invention provides a multiport configurable switch for switching variable length packets, the multiport switch including: (a) A plurality of input ports. (b) A plurality of output ports. (c) A configurable switching unit, coupled to the plurality of input ports and output ports, responsive to configuration signals for allowing to couple an input port with an output port. (d) A connection request generator, coupled to the input ports, for detecting awaiting variable length packets within the input ports, for determining the output ports associated to the awaiting variable length packets and generating connection requests reflecting the determination. (e) A scheduler, coupled to the connection request generator, to the plurality of programmable switching means, wherein the scheduler receives the connection requests; periodically selects out of the received connection requests selected connection requests, each selected connection request for switching a variable length packet from an input port to an output port wherein both the input port and the output port were not previously scheduled to be busy during the next time slot; provides the configurable switching unit configuration signals such that the selected connection requests are serviced during the next time slot; and notifying the input ports which connection requests are scheduled to be serviced during the next time slot.

The invention provides a multiport switch wherein the scheduler stores status information representative of input ports and output ports that are busy during the current time slot and which input ports and output ports are scheduled to be busy during the next time slot.

The invention provides a multiport switch wherein each input port includes of a plurality of input queues, for differentiating between variable length packets according to at least one of the following parameters: the priority of the variable length packet, the output port associated with the variable length packet, the number of output ports associated to a single variable length packet, for example unicast, multicast or broadcast, and to the type of flow, such as unidirectional, bi-directional flow.

The invention provides a multiport switch wherein each connection request generator provides the scheduler an END signal indicating that a forwarding of a variable length packet is scheduled to end during the current time slot. Usually, the presence of END signals is periodically checked.

The invention provides a multiport switch wherein the scheduler selects a received connection request by converging on a conflict free match in multiple iterations.

The invention provides a multiport switch wherein the scheduler selections are based upon a rotating priority arbitration scheme.

The invention provides a multiport switch for switching variable length packets, the switch including: (a) A plurality of input ports and output ports; wherein each input port receives a variable length packet; determines an output port associated to the variable length packet; generates a connection request for forwarding the variable length packet from the input port to the output port; tracks a provision of the variable length packet to a plurality of programmable switching units to detect that a transmission of a variable length packet across the crossbar ends during a current time slot, and accordingly sends an END signal. (b) A configurable switching unit, coupled to the plurality of input ports and output ports, responsive to configuration signals, for allowing for coupling an input port with an output port. (c) A scheduler, coupled to the connection request generator, to the plurality of programmable switching means and to the input ports, wherein the scheduler receives the connection requests and the END signals; periodically selects a configuration of the configurable switching units based upon these signals; provides the configurable switch unit configuration signals for allowing to service the selected connection requests; and notifies the input ports which connection requests are scheduled to be serviced during the next time slot.

The invention provides a multiport switch wherein each input port further includes a plurality of queues and a queuing manager; wherein the queuing manager is adapted to receive a variable length packet, to determine in which queue out of the plurality of queues of the input port to store the received variable length packet and to generate a length indication indicating a length of the variable length packet.

The invention provides a scheduler for scheduling a configurable switching unit, the scheduler receives a connection request for forwarding a variable length packet from an input port to the output port of the multiport switch; wherein the scheduler periodically selects out of the received connection requests selected connection requests, each selected connection request for switching a variable length packet from an input port to an output port wherein both the input port and the output port were not previously scheduled to be busy during the next time slot; and wherein the scheduler provides the configurable switching unit configuration signals such that the selected connection requests are serviced during the next time slot.

The invention provides a scheduler that selects connection requests by converging on a conflict free match in multiple iterations.

The invention provides a scheduler that selects connection requests by implementing a rotating priority arbitration scheme.

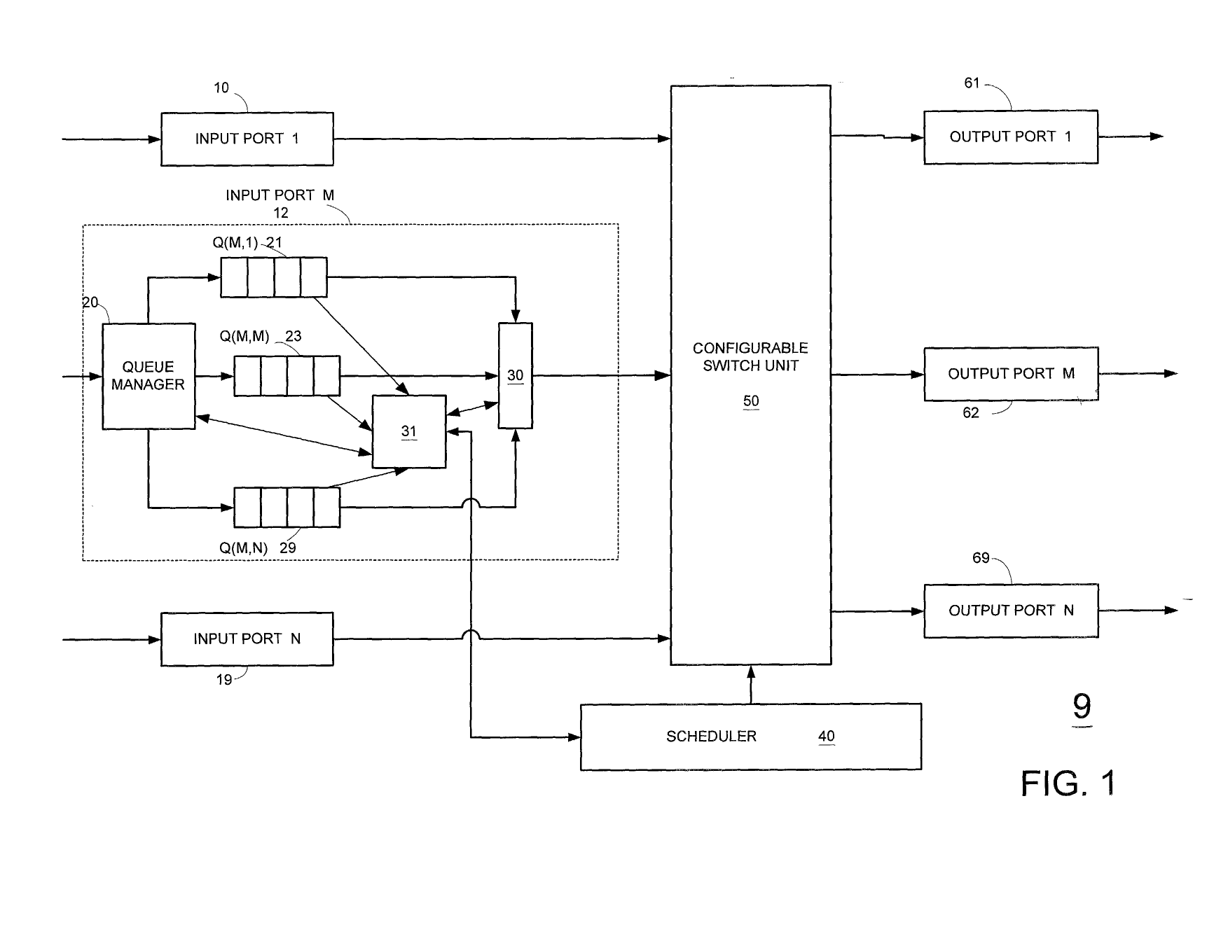

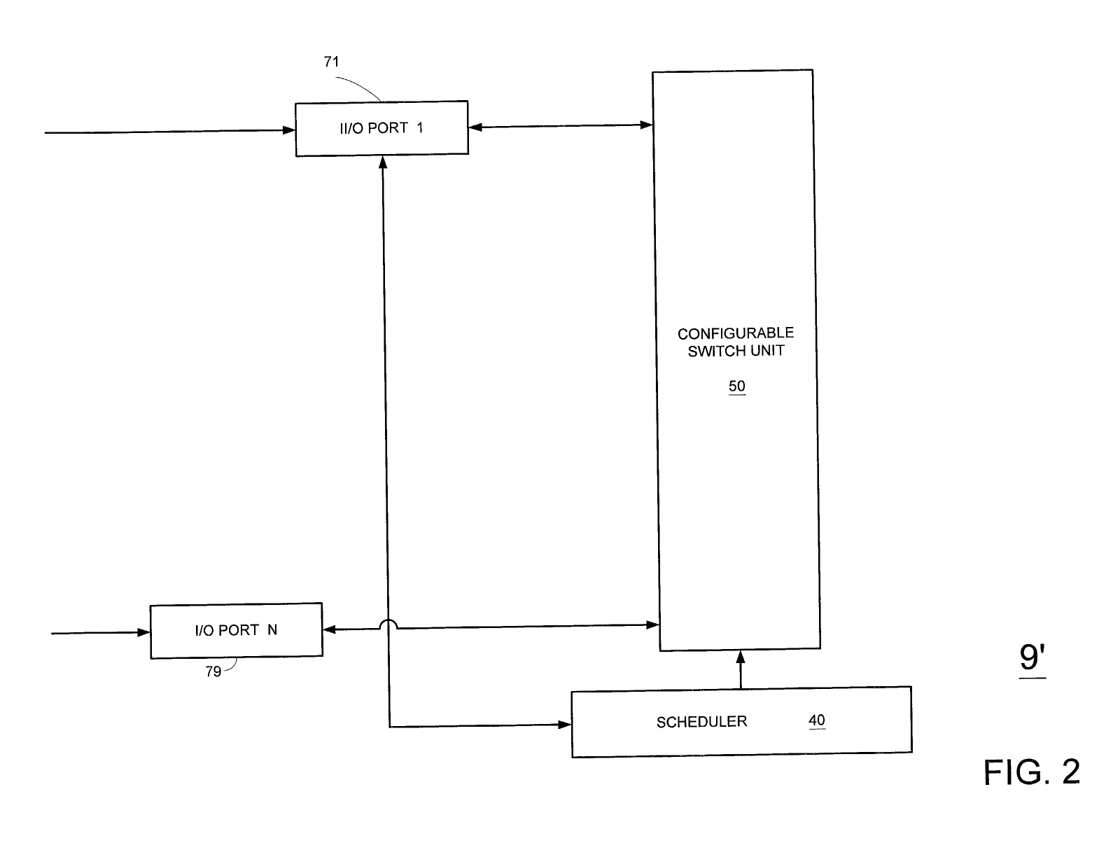

FIG. 1 is a schematic diagram of multiport switch 9, according to a preferred embodiment of the invention. FIG. 2 illustrates multiport switch 9″ having Input/Output (I/O) ports.

Multiport switch 9 has a plurality of input ports INPUT PORT 1-INPUT PORT N 10-19, a plurality of output ports OUTPUT PORT 1-OUTPUT PORT N 60-69, configurable switch unit 50 and scheduled 40. Input ports 10-19 have inputs for receiving variable length packets and further have outputs for providing variable length packets to configurable switch unit 50. Configurable switch unit 50 is able to couple input ports to output ports in response to configuration signals from scheduler 40. Output ports 60-69 have inputs for receiving variable length packets from configurable switch unit 50 and have outputs for outputting the variable length packets to external devices or apparatuses coupled to multiport switch 9. Each output port can have at least one output queue for supporting quality of service requirements, for supporting priority levels or for enhancing the fairness of the scheduling.

Scheduler 40 is coupled to input ports 10-19 for receiving forwarding requests from the input ports and for providing input ports 10-19 response information. Scheduler 40 is able to determine the configuration of configurable switch unit 50 by implementing various arbitration schemes, such as but not limited to rotating priority (round robin) arbitration schemes.

For convenience of explanation, it is assumed that multiport switch 9 allows unidirectional flow between any input port to any output port. However, the present invention is readily adapted to accommodate a lower degree of connectivity, bidirectional flow of variable length packets. FIGS. 1-2 illustrates a centralized scheduler, although the scheduling of multiport switch 9 can be performed in a distributed manner. For example, the scheduling can be implemented by local scheduling units, including input scheduling units and output scheduling units preferably located within input ports and output ports accordingly. The input scheduling units send forwarding requests to the output scheduling units. These forwarding requests do not include forwarding requests that are associated to input ports and/or output ports that are previously scheduled to be busy during the next time slot. The output scheduling units within output ports that receive forwarding requests select a granted forwarding request and notify the input scheduling units. Input scheduling units located within input ports that receive the granted forwarding request select an accepted forwarding request to be serviced during the next time slot. The input scheduling units provide configurable switching unit 50 configuration signals so that the accepted forwarding requests can be serviced. Configurable switching unit 50 also allows for continuing the forwarding of variable length packets that are scheduled to continue during the next time slot.

Input ports, such as INPUT PORT M 12 maintain an output queue for each possible output port, but other queues configurations can be accommodated by the present invention. For example, each input port can have at least one input queue, for guaranteeing quality of service, for supporting priorities, for enhancing the fairness of handling arriving variable length packets, for eliminating HOL blocking, and for allowing and enhancing multicast and broadcast capabilities. Input port 12 has N queues Q(M,1)-Q(M,N) 21-29, for storing variable length packets destined to output ports 1-N respectively. Input port 12 further includes queue manager 20 that receives variable length packets, extracts from each received variable length packet status information and accordingly determines the output port of the variable length packet. Based upon this determination queue manager 20 provides the variable length packet to the input queue that is associated with the output port. According to one aspect of the invention each queue has a first portion for storing the variable length packets and a second portion for storing received packet information. The received packet information includes a length indication, an output port indication and a pointer that points to a location of a variable length packet within the first portion. The received packet information can include additional information such as but not limited to a priority level, required quality of service indication and a delay indication. Usually, the received packet information that is located at the top of each queue is provided to connection request generator 31 that in turn generates a connection request for forwarding variable length packets that are stored at the top of queues Q(M,1)-Q(M,N) 21-29. The connection requests are sent to scheduler 40.

According to one aspect of the invention, each input port provides END signals to scheduler 40 when it detects that the forwarding of a variable length packet from the input port is scheduled to end during the current time slot. The detection can be implemented by tracking the forwarding of the variable length packet and calculating the time remaining until a forwarding process ends. This process can be implemented by various means, such as constantly updating the length indication to indicate a remaining portion of the variable length packet and comparing it to a threshold that reflect the amount of information that can be transferred during a predetermined period. Usually, the detection is triggered at the beginning of each time slot. For example, if 32 bits are transmitted during each time slot, the input port will generates an END signal if at the beginning of a current time slot up to 32 bits of the variable length packet remain.

Multiport switch 9 ignores connection requests that are associated with either input ports or output ports that were previously scheduled to be busy during the next time slot. Accordingly, if during a previous time slot either an input port or an output port were scheduled to be coupled to each other for forwarding a variable length packet, and the forwarding is not scheduled to end during the current time slot, then new forwarding requests associated to either of these ports are not serviced during the next time slot. Usually, connection request generator 31 can mask connection requests from an input port if that input port is scheduled to continue to forward a variable length packet during the next time slot. Scheduler 40 can mask new connection requests associated to either input or output ports.

Scheduler 40 receives the connection requests and the END signals. It periodically selects a configuration of the configurable switching unit 50 based upon new un-masked connection requests and the END signals. Scheduler 40 can implement various arbitration schemes to determine the configuration of configurable switch unit 50. According to an aspect of the invention, scheduler 40 does not stop a transmission of a variable length packet that has already started. Based upon the determination, scheduler 40 provides configurable switch unit 50 configuration signals for allowing to service the new and old selected connection requests. Scheduler 40 also notifies the input ports that sent the selected forwarding requests. Input ports that were received a positive response from scheduler 40 will start forwarding variable length packets during the next time slot.

The END signal can be sent from an input port to scheduler 40 in various manners. For example, such a signal can be sent over a dedicated line, or during a predetermined “window” within a time slot. According to an aspect of the invention the END signal is encoded in the connection requests. For example, a connection request goes “low” at a predetermined period before end of the forwarding of a variable length packet. Accordingly, these variable length packets have to be at least two “time slot” long.

Table 1 illustrates the scheduling of a multiport switch that has four I/O ports. The first four columns denoted FRQ illustrate flow request from a source port to a destination port. FRQ 1,2 means a request to connect port 1 to port 2 for forwarding a variable length packet from port 1 to port 2. IGNORE denotes the input and output ports that are scheduled to be coupled during a next time slot, so that flow requests that are associated to either of these ports are ignored. The two columns denoted RESP illustrate response information that indicates which ports are scheduled to be coupled to each other during the next time slot. “END” illustrates an end of variable length packet indication. This indication indicates that a current transmission of a variable length packet is scheduled to end during the current time slot. T1 . . . T6 represent consecutive time slots.

TABLE 1

| | FRQ | FRQ | FRQ | FRQ | IGNORE | REPS | RESP |
|---|---|---|---|---|---|---|---|
| T1 | 1, 4 | 1, 3 | 2, 3 | 2, 4 | — | 1, 4 | 2, 3 |
| T2 | END | 1, 3 | 2, 3 | 2, 4 | 2, 3 | | 2, 3 |
| T3 | | 1, 3 | END | 2, 4 | — | 1, 3 | 2, 4 |
| T4 | 1, 2 | 1, 3 | | 2, 4 | 1, 2, 3, 4 | 1, 3 | 2, 4 |
| T5 | 1, 2 | END | 3, 4 | END | — | 1, 2 | 3, 4 |
| T6 | 1, 2 | | 3, 4 | | 1, 2, 3, 4 | 1, 2 | 3, 4 |

The scheduling process starts at a first time slot T1. At T1 there are four transfer requests to transfer a variable length packet from port 1 to port 4, from port 1 to port 3, from port 2 to port 3 and from port 2 to port 3. The first and the third requests have higher priority and they are scheduled to be serviced during the next time slot T2. As the variable length packets can arrive at any moment, the requests can be generated at any moment but are checked at the beginning of each time slot.

At second time slot T2 two transfer requests are serviced (1,4) and (2,3). The forwarding of a variable packet from port 1 to port 4 is scheduled to end during T2, as indicated by END at the second column of table 1 and accordingly forwarding requests associated to ports 2 and 3 can be taken into account at the next arbitration process. There are two forwarding requests that were not serviced (1,3) and (2,4). Because the first forwarding request is associated with port 3 and the second is associated with port 2 none of these forwarding request can be serviced during T3. Accordingly, during T3 only request (1,3) is serviced.

The forwarding of a variable packet from port 2 to port 3 is scheduled to end during T4, as indicated by END at the fourth column of table 1 and accordingly forwarding requests associated to ports 1 and 4 can also be taken into account when determining which forwarding requests to grant during T4. Accordingly, forwarding request (1,3) and (2,4) are scheduled to be serviced during T4.

At time slot T4 two forwarding requests (1,3) and (2,4) are serviced and accordingly requests associated to each of the ports are ignored.

The forwarding of variable length packets from port 1 to port 3 and from port 2 to port 4 is scheduled to end during T5. Accordingly, forwarding requests associated with all ports can be taken into account. In view of the existing forwarding requests, two forwarding requests (1,2) and (3,4) are scheduled to be serviced during time slot T6.

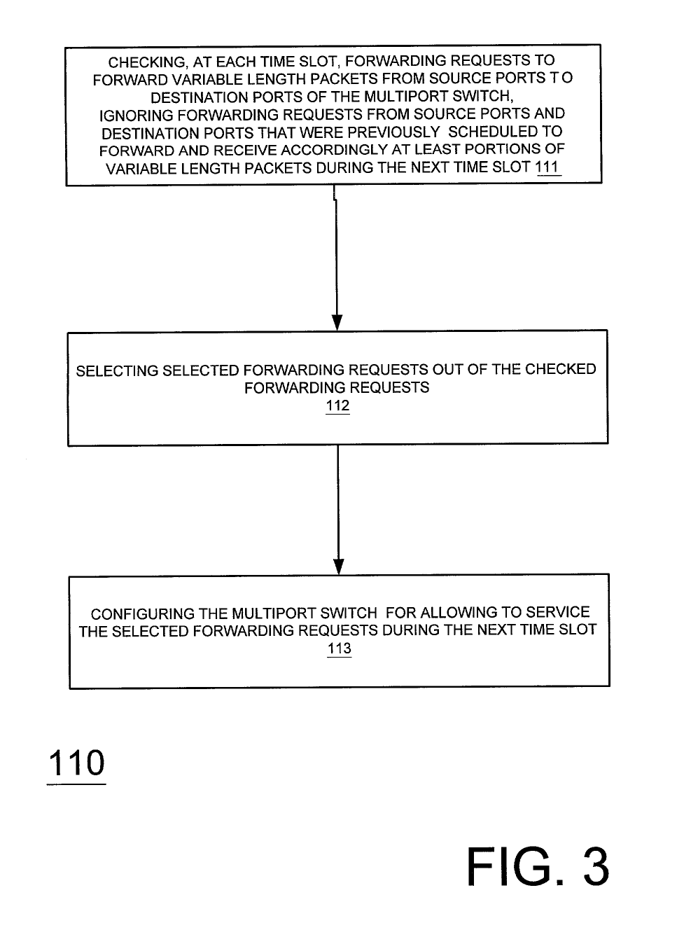

FIG. 3 is a flow chart illustrating method 110 for forwarding variable length packets across a multiport switch. Method 110 includes steps 111, 112 and 113. Method 110 starts by step 111 of checking, at each time slot, forwarding requests to forward variable length packets from source ports of the multiport switch to destination ports of the multiport switch, wherein ignoring forwarding requests from source ports that were previously scheduled to forward at least a portion of a variable length packet during a next time slot and ignoring forwarding requests from destination ports that are scheduled to receive at least a portion of a variable length packet during the next time slot. Referring to the example set forth at FIG. 1, forwarding request generator 31 tracks the forwarding of variable length packet forwarded from input port 12 to determine whether the forwarding of the variable length packets ends during the current time slot, and accordingly to determine when to send an END signal to scheduler 40. Scheduler 40 ignores forwarding requests from input 12 as long as a variable length packet is sent from input port 12. Conveniently, a forwarding request is generated when a variable length packet reaches the top of one of queues Q(M,1)-Q(M,N). This variable length packet was previously received by input port 12 and was stored in the most appropriate queue out of Q(M,1)-Q(M,N) Step 111 is followed by step 112 of selecting selected forwarding requests out of the checked forwarding requests. The checked forwarding requests do not include ignored forwarding requests. Referring to the example set fourth at FIG. 1, scheduler 40 selects which selected requests to service during the next time slot.

Step 112 is followed by step 113 configuring the multiport switch for allowing to service the selected forwarding requests during the next time slot. Referring to the example set fourth at FIG. 1, scheduler 40 provides configuration signals to configurable switching unit 50 during the next time slot that reflect the selected forwarding requests. Usually, step 113 further comprises a step of notifying source ports that issued selected forwarding requests about the selection. Each of these input ports provides a variable length packet during the next time slot.

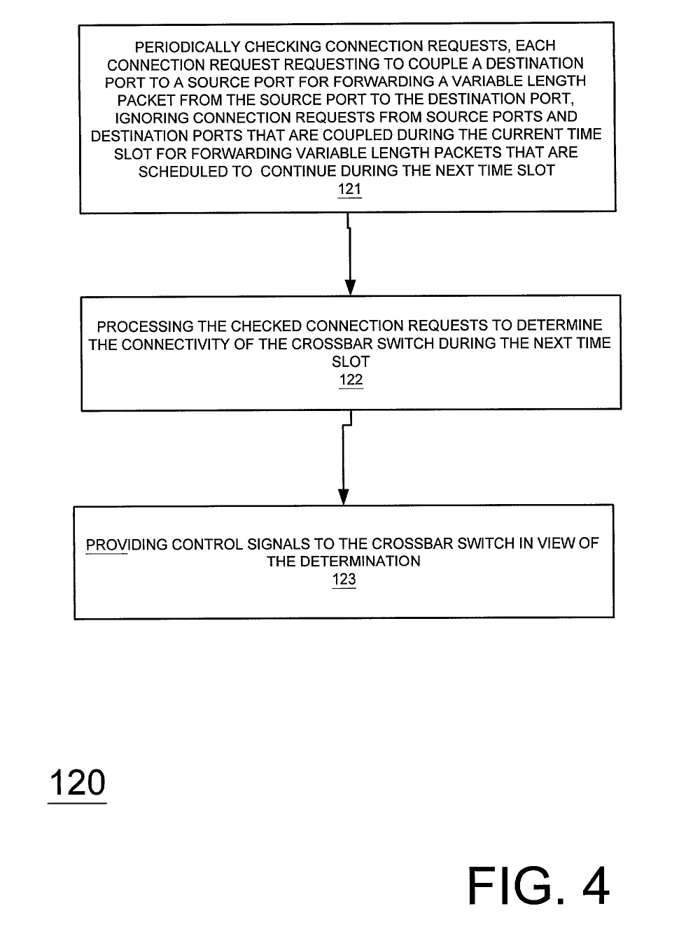

FIG. 4 is a flow chart illustrating method 120 for controlling a crossbar switch having multiple ports. Method 120 includes steps 121, 122 and 123.

Method 120 starts by step 121 of periodically checking connection requests, each connection request requesting to couple a destination port of the crossbar switch to a source port of the crossbar switch, for forwarding a variable length packet from the source port to the destination port; wherein ignoring connection requests associated with each source port and destination port that is coupled to another destination port and another source port accordingly during a current time slot for forwarding at least a portion of a variable length packet, wherein the forwarding of the variable length packet is not scheduled to end during the current time slot.

Step 121 is followed by step 122 of processing the checked connection requests to determine the connectivity of the crossbar switch during the next time slot. Checked connection requests do not include ignored forwarding requests Step 122 is followed by step 123 of providing control signals to the crossbar switch in view of the determination.

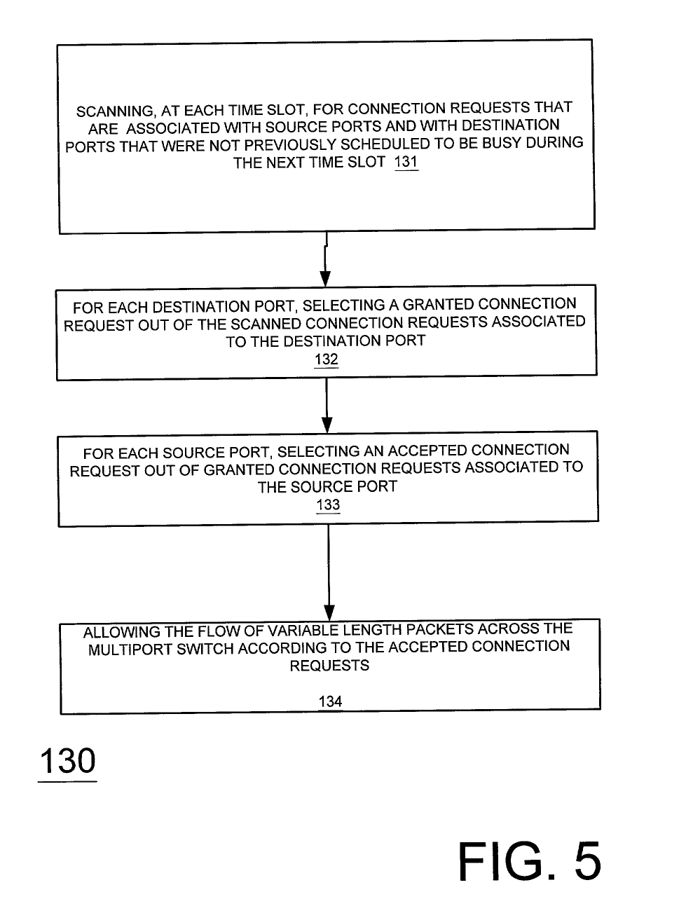

FIG. 5 is a flow chart illustrating method 130 for periodically controlling the flow of variable length packets across a multiport switch. Method 130 includes steps 131, 132, 133 and 134. Step 131 of scanning, at each time slot, for connection requests that are associated with source ports and to destination ports that are not scheduled to be busy during the next time slot. Step 131 is followed by step 132 of selecting a granted connection request, for each destination port that is associated with a scanned connection request. The scanned connection requests do not include connection requests that are ignored during step 131. Step 132 is followed by step 133 of selecting an accepted connection request, for each source port that is associated with a granted connection request. Step 133 is followed by step 134 of allowing variable length packets to flow across the multiport switch according to the accepted connection requests.

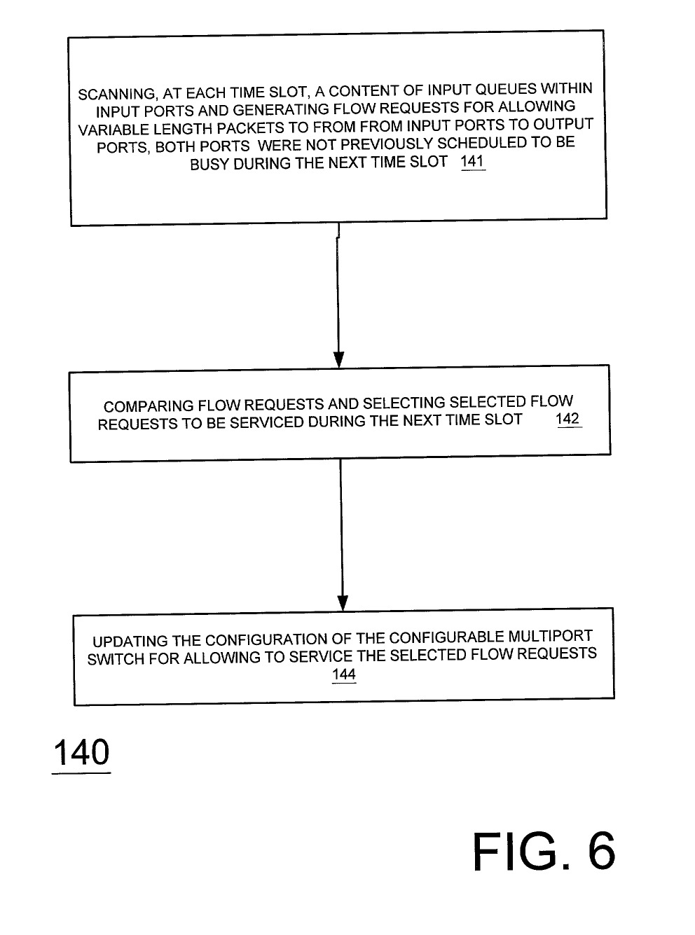

FIG. 6 is a flow chart illustrating method 140 for controlling a configuration of a multiport switch for allowing variable length packets to flow from an input port to at least one output port of the multiport switch. Method 140 includes steps 141, 142 and 143. Method 140 starts at step 141 of scanning, at each time slot, a content of input queues within the input ports and generating flow requests for allowing variable length packet stored within the input queues to flow from input ports that were not previously scheduled to be busy during the next time slot to output ports that were not previously scheduled to be busy during the next time slot. Step 141 is followed by step 142 of comparing flow requests and selecting selected flow requests to be serviced during the next time slot. Step 142 is followed by step 143 of updating the configuration of the configurable multiport switch for allowing for servicing the selected flow requests.

Accordingly, the above disclosed subject matter is to be considered illustrative and not restrictive, and to the maximum extent allowed by law, it is intended by the appended claims to cover all such modifications and other embodiments which fall within the true spirit and scope of the present invention. The scope of the invention is to be determined by the broadest permissible interpretation of the following claims and their equivalents rather then the foregoing detailed description.

We claim:

1. A method for forwarding variable length packets across a multiport switch, the method comprising the steps of:
checking, at each time slot, forwarding requests to forward variable length packets from source ports of the multiport switch to destination ports of the multiport switch, wherein ignoring forwarding requests from source ports that were previously scheduled to forward at least a portion of a variable length packet during a next time slot and ignoring forwarding requests from destination ports that are scheduled to receive at least a portion of a variable length packet during the next time slot;
selecting selected forwarding requests out of the checked forwarding requests; and
configuring the multiport switch for allowing to service the selected forwarding requests during the next time slot.

2. The method of claim 1 further comprises a step of tracking the forwarding of each variable length packet across the multiport switch to determine whether the forwarding ends during the current time slot.

3. The method of claim 1 further comprises a step of notifying source ports that issued selected forwarding requests about the selection.

4. The method of claim 1 wherein the step of checking is preceded by a step of receiving variable length packets at a source port, storing the variable length packets at a queue out of at least one queue of the source port, wherein the forwarding request reflects at least a portion of the content of the queue.

5. The method of claim 4 further comprises a step of maintaining at each source port a queue for each level of priority of each source port, and a step of storing a variable length packet according to the priority of the variable length packet.

6. The method of claim 4 further comprises a step of maintaining at each source port a queue for each destination port, and a step of storing a variable length packet according to the destination port of the variable length packet.

7. The method of claim 1 further comprises a step of periodically tracking the forwarding of variable length packets to determine when the forwarding of the variable length packets ends.

8. The method of claim 7 wherein the step of tracking comprises a step of receiving a length indication being indicative of a length of a variable length packet and of a step of updating the length indication during the forwarding of the variable length packet to reflect a remaining time period until the forwarding ends.

9. The method of claim 1 wherein the step of selecting further comprises a step of converging on a conflict free match.

10. The method of claim 1 wherein the step of selecting is based upon a rotating priority arbitration scheme.

11. A method for controlling a crossbar switch having multiple ports, the method comprising the steps of:
periodically checking connection requests, each connection request requesting to couple a destination port of the crossbar switch to a source port of the crossbar switch, for forwarding a variable length packet from the source port to the destination port; wherein ignoring connection requests associated with each source port and destination port that is coupled to another destination port and another source port accordingly during a current time slot for forwarding at least a portion of a variable length packet, wherein the forwarding of the variable length packet is not scheduled to end during the current time slot;
processing the checked connection requests to determine the connectivity of the crossbar switch during the next time slot; and
providing control signals to the crossbar switch in view of the determination.

12. The method of claim 11 further comprises a step of maintaining a crossbar switch status database indicative of the connectivity of the crossbar switch during at least the current time slot and the next time slot.

13. The method of claim 11 further comprises a step of receiving an END signal being indicative that a forwarding of a variable length packet is scheduled to end during the current time slot.

14. The method of claim 11 wherein the END signal is encoded in the connection requests.

15. The method of claim 11 wherein maintaining a connection between a source port and a destination port throughout the forwarding of the variable length packet.

16. The method of claim 11 wherein the step of processing the connection requests further comprises a step of converging on a conflict free match.

17. The method of claim 11 wherein the step of processing the connection requests is based upon a rotating priority arbitration scheme.

18. A method for periodically controlling the flow of variable length packets across a multiport switch, the method comprising the steps of:
scanning, at each time slot, for connection requests that are associated with source ports and to destination ports that are not scheduled to be busy during the next time slot;
selecting a granted connection request, for each destination port that is associated with a scanned connection request;
selecting an accepted connection request, for each source port that is associated with a granted connection request; and
allowing variable length packets to flow across the multiport switch according to the accepted connection requests.

19. The method of claim 18 wherein maintaining a connection between a source port and a destination port throughout the flow of the variable length packet.

20. The method of claim 18 wherein the steps of selecting further comprise a step of converging on a conflict free match in multiple iterations.

21. The method of claim 18 wherein the steps of selecting are based upon a rotating priority arbitration scheme.

22. A method for controlling a configuration of a multiport switch for allowing variable length packets to flow from an input port to at least one output port of the multiport switch, the method comprising the steps of:
scanning, at each time slot, a content of input queues within the input ports and generating flow requests for allowing variable length packet stored within the input queues to flow from input ports that were not previously scheduled to be busy during the next time slot to output ports that were not previously scheduled to be busy during the next time slot;
comparing flow requests and selecting selected flow requests to be serviced during the next time slot; and
updating the configuration of the configurable multiport switch for allowing to service the selected flow requests.

23. The method of claim 22 wherein each input port maintains a plurality of input queues, for differentiating between variable length packets according to at least one parameter selected from the group of:
variable length packet priority;
output port;
number of output ports to which the variable length packet is destined;
type of flow.

24. The method of claim 22 wherein maintaining a connection between a source port and a destination port throughout the flow of the variable length packet.

25. The method of claim 22 wherein the step of selecting further comprises a step of converging on a conflict free match in multiple iterations.

26. The method of claim 22 wherein the step of selecting is based upon a rotating priority arbitration scheme.

27. A multiport configurable switch for switching variable length packets, the switch comprising:
a plurality of input ports;
a plurality of output ports;
a configurable switching unit, coupled to the plurality of input ports and output ports, responsive to configuration signals for allowing to couple an input port with an output port;
a connection request generator, coupled to the input ports, for detecting awaiting variable length packets within the input ports, for determining the output ports associated to the awaiting variable length packets and generating connection requests reflecting the determination; and
a scheduler, coupled to the connection request generator, to the plurality of programmable switching means, wherein the scheduler
(i) receives the connection requests;
(ii) periodically selects out of the received connection requests selected connection requests, each selected connection request for switching a variable length packet from an input port to an output port wherein both the input port and the output port were not previously scheduled to be busy during the next time slot;
(iii) provides the configurable switching unit configuration signals such that the selected connection requests are serviced during the next time slot; and
(iv) notifying the input ports which connection requests are scheduled to be serviced during the next time slot.

28. The multiport switch of claim 27 wherein the scheduler stores status information representative of input ports and output ports that are busy during the current time slot and which input ports and output ports are scheduled to be busy during the next time slot.

29. The multiport switch of claim 27 wherein each input port comprises of a plurality of input queues, for differentiating between variable length packets according to at least one parameter selected from the group of:
variable length packet priority;
output port;
number of output ports to which the variable length packet is destined;
type of flow.

30. The multiport switch of claim 27 wherein each connection request generator provides the scheduler an END signal indicating that a forwarding of a variable length packets is scheduled to end during the current time slot.

31. The multiport switch of claim 27 wherein the scheduler selects by converging on a conflict free match.

32. The multiport switch of claim 27 wherein the scheduler selections are based upon a rotating priority arbitration scheme.

33. A multiport switch for switching variable length packets, the switch comprising:
a plurality of input ports and output ports; wherein each input port
(i) receives a variable length packet;
(ii) determines an output port associated to the variable length packet;
(iii) generates a connection request for forwarding the variable length packet from the input port to the output port;
(iv) tracks a provision of the variable length packet to a plurality of programmable switching units to detect that a transmission of a variable length packet across the crossbar ends during a current time slot, and accordingly sends an END signal;
a configurable switching unit, coupled to the plurality of input ports and output ports, responsive to configuration signals, for allowing to couple an input port with an output port; and
a scheduler, coupled to the connection request generator, to the plurality of programmable switching means and to the input ports, wherein the scheduler
(i) receives the connection requests and the END signals;
(ii) periodically selects a configuration of the configurable switching units based upon these signals;
(iii) provides the configurable switch unit configuration signals for allowing to service the selected connection requests; and
(iv) notifies the input ports which connection requests are scheduled to be serviced during the next time slot.

34. The multiport switch of claim 33 wherein each input port further comprises a plurality of queues and a queuing manager; wherein the queuing manager is adapted to receive a variable length packet, to determine in which queue out of the plurality of queues of the input port to store the received variable length packet and to generate a length indication indicating a length of the variable length packet.

35. A scheduler for scheduling a configurable switching unit, the scheduler receives a connection request for forwarding a variable length packet from an input port to the output port of the multiport switch;
wherein the scheduler periodically selects out of the received connection requests selected connection requests, each selected connection request for switching a variable length packet from an input port to an output port wherein both the input port and the output port were not previously scheduled to be busy during the next time slot; and
wherein the scheduler provides the configurable switching unit configuration signals such that the selected connection requests are serviced during the next time slot.

36. The scheduler of claim 35 wherein the scheduler selects by converging on a conflict free match in multiple iterations.

37. The scheduler of claim 35 wherein the scheduler selections are based upon a rotating priority arbitration scheme.
